(19) United States
(12) Patent Application Publication
(10) Pub. No.: US 2019/0301919 A1
(43) Pub. Date: Oct. 3, 2019

(54) UNIPOLAR RESISTIVE LADDER SENSOR

(71) Applicant: HAMLIN ELECTRONICS (SUZHOU) CO. LTD., Suzhou, Jiangsu (CN)

(72) Inventors: Stephen E. Knapp, Park Ridge, IL (US); Ioannis Anastasiadis, Norwich (GB); Bens Xie, Jiangsu (CN)

(73) Assignee: HAMLIN ELECTRONICS (SUZHOU) CO. LTD., Suzhou, Jiangsu (CN)

(21) Appl. No.: 16/348,238

(22) PCT Filed: Nov. 8, 2016
(86) PCT No.: PCT/CN2016/105058

§ 371 Date: May 8, 2019

(51) Int. Cl. G01F 23/74; G01F 23/76

(52) U.S. Cl. CPC G01F 23/74; G01F 23/76

(57) ABSTRACT

A unipolar resistive ladder fluid-level sensor is provided. The sensor may include a tube immersed in a fluid, the tube containing a plurality of unipolar switches, and a float concentrically surrounding the tube. The float is configured to float in the fluid and to move relative to the tube in an axial direction as a height of the fluid level changes. The fluid-level sensor may further include a permanent magnet coupled to the float, wherein the plurality of unipolar switches are responsive to a magnetic field produced by the permanent magnet, and wherein the permanent magnet is one of: radially magnetized, and axially magnetized. In some approaches, the unipolar sensor is either a south-pole or north-pole activated sensor. In some approaches, at least one of the unipolar switches changes position in response to a negative magnetic field in an activation range of less than 1.0 millimeter.

### BACKGROUND OF THE DISCLOSURE

### Field of the Disclosure

The present disclosure relates to a sensor for measuring fluid levels and, in particular, to a high-precision unipolar switch responsive to only one pole of a radial or axial magnetized magnet.

### Discussion of Related Art

Fluid level sensors are widely used in the petroleum, chemical, power, environmental, and other fields, for example, to continuously measure the fluid level or pressure within a vessel. Fluid-level sensors are also often applied in a system used to control the level or set an alarm related to the level of a fluid. Presently, these devices commonly use reed switches or Hall sensors. The structure of fluid-level sensors using reed switches is relatively simple and inexpensive, and can be applied to controlling or measuring. The general working principle of reed switches involves a magnetic float that moves up and down with the fluid level, providing a moving magnetic field that changes the state of the reed switches. In this structure, when the magnetic float is at the height of a reed switch, the reed switch will be closed by the magnetic field, thus forming a closed circuit. When the magnetic float moves away from the reed switch, the switch opens due to the mechanical spring action of the reed, leaving an open circuit. The reed switches may be connected to a resistive network, such that the current measured at the level sensor output varies as a function of the float height. The current signal thus corresponds to and determines the fluid level.

Reed switches may be susceptible to switch failure, however, leading to an erroneous reading. Furthermore, because switches are relatively large, the resolution of this type of fluid-level sensor is limited. Still yet, reed switches may be damaged by impact, abrasion, and vibration, which can crack the glass envelope, and which makes the sensors difficult to install and solder. Additionally, when there are inductive or capacitive loads attached to the level sensor, the service life of the level sensor will be affected. Moreover, reed switch based level sensors have an analog output, and they are thus not immune to external electromagnetic interference, so often they need some sort of digital processing circuit to accurately convert the analog signal into a digital signal.

The working principle of Hall sensor based fluid-level sensors is similar, except that Hall switches are used instead of reed switches. Hall sensors are generally smaller and easier to install and solder, and because hall sensors have digital output through an internal A/D convertor, they have better immunity to electromagnetic interference. Unfortunately, Hall switches have high current consumption, on the order of milliamps, so battery powered fluid-level sensors require frequent maintenance and replacement, increasing operational cost.

### SUMMARY OF THE DISCLOSURE

In view of the foregoing, what is needed is a sensor providing increased switch point accuracy and, in particular, a high-precision unipolar switch responsive to only one pole of a radial or axial magnetized magnet.

An exemplary fluid-level sensor according to embodiments of the disclosure may include a tube immersed in a fluid, the tube containing a plurality of unipolar switches, and a float concentrically surrounding the tube, the float configured to float in the fluid and to move relative to the tube in an axial direction as an amount of the fluid level changes. The fluid-level sensor may further include a permanent magnet coupled to the float, wherein the plurality of unipolar switches are responsive to a magnetic field produced by the permanent magnet, and wherein the permanent magnet is one of: radially magnetized, and axially magnetized.

An exemplary system for measuring fluid levels according to embodiments of the disclosure may include a tube immersed in a fluid, the tube containing a plurality of unipolar switches, and a float concentrically surrounding the tube, the float configured to float in the fluid and to move relative to the tube in an axial direction as a height of the fluid level changes. The system may further include a permanent magnet positioned within the float, wherein the plurality of unipolar switches are responsive to a magnetic field produced by the permanent magnet, and wherein the permanent magnet is one of: radially magnetized, and axially magnetized.

An exemplary unipolar resistive ladder sensor according to embodiments of the disclosure may include a tube immersed in a fluid, the tube containing a plurality of unipolar switches, and a float concentrically surrounding the tube, the float configured to float in the fluid and to move relative to the tube in an axial direction as a height of the fluid level changes. The fluid-level sensor may further include a permanent magnet disposed within the float, wherein each of the plurality of unipolar switches is responsive to only one pole at a leading edge of the permanent magnet, and wherein the permanent magnet is one of: radially magnetized, and axially magnetized.

### BRIEF DESCRIPTION OF THE DRAWINGS

The accompanying drawings illustrate exemplary approaches of the disclosed a fluid-level sensor so far devised for the practical application of the principles thereof, and in which:

FIG. 1 is an isometric view illustrating a fluid-level sensor according to exemplary embodiments of the disclosure;

FIG. 2 is a side cross-sectional view of the fluid-level sensor of FIG. 1 within a containment vessel according to exemplary embodiments of the disclosure;

FIG. 3 is a schematic of the fluid-level sensor of FIG. 1 according to exemplary embodiments of the disclosure;

FIG. 4 is a side view illustrating operation of the fluid-level sensor of FIG. 1 according to exemplary embodiments of the disclosure;

FIG. 5 is graph illustrating operation of the fluid-level sensor of FIG. 1 employing a radially magnetized magnet according to exemplary embodiments of the disclosure; and

FIG. 6 is graph illustrating operation of the fluid-level sensor of FIG. 1 employing an axially magnetized magnet according to exemplary embodiments of the disclosure.

The drawings are not necessarily to scale. The drawings are merely representations, not intended to portray specific parameters of the disclosure. Furthermore, the drawings are intended to depict exemplary embodiments of the disclosure, and therefore is not considered as limiting in scope.

Furthermore, certain elements in some of the figures may be omitted, or illustrated not-to-scale, for illustrative clarity. The cross-sectional views may be in the form of “slices”, or “near-sighted” cross-sectional views, omitting certain background lines otherwise visible in a “true” cross-sectional view, for illustrative clarity. Furthermore, for clarity, some reference numbers may be omitted in certain drawings.

### DESCRIPTION OF EMBODIMENTS

The present disclosure will now proceed with reference to the accompanying drawings, in which various approaches are shown. It will be appreciated, however, that the unipolar sensor may be embodied in many different forms and should not be construed as limited to the approaches set forth herein. Rather, these approaches are provided so that this disclosure will be thorough and complete, and will fully convey the scope of the disclosure to those skilled in the art. In the drawings, like numbers refer to like elements throughout.

As used herein, an element or operation recited in the singular and proceeded with the word “a” or “an” should be understood as not excluding plural elements or operations, unless such exclusion is explicitly recited. Furthermore, references to “one approach” or “one embodiment” of the present disclosure are not intended to be interpreted as excluding the existence of additional approaches and embodiments that also incorporate the recited features.

Furthermore, spatially relative terms, such as “beneath,” “below,” “lower,” “central,” “above,” “upper,” “proximal,” “distal,” and the like, may be used herein for ease of describing one element's relationship to another element(s) as illustrated in the figures. It will be understood that the spatially relative terms may encompass different orientations of the device in use or operation in addition to the orientation depicted in the figures.

As disclosed herein, embodiments of the disclosure provide linear sensing using any number of discrete switch points to provide increased switch point accuracy. For the sake of explanation, embodiments of the disclosure will hereinafter be described in the non-limiting context of a fluid-level sensor including a tube immersed in a fluid, the tube containing a plurality of unipolar switches, and a float concentrically surrounding the tube. The float is configured to float in the fluid and to move relative to the tube in an axial direction as a height of the fluid level changes. The fluid-level sensor may further include a permanent magnet coupled to the float, wherein the plurality of unipolar switches are responsive to a magnetic field produced by the permanent magnet, and wherein the permanent magnet is one of: radially magnetized, and axially magnetized. In some approaches, the unipolar sensor is either a south-pole or north-pole activated sensor responsive to only one pole, for example, at a leading edge of the permanent magnet. In some approaches, at least one of the unipolar switches changes position in response to a negative magnetic field in an activation range of less than 1.0 millimeter.

As a result, embodiments of the disclosure provide improved switch point accuracy by using unipolar selective sensors paired with radial or axially magnetized magnets possessing a leading edge of opposite polarity to that of the unipolar sensors. For example, in the case of an S-pole activated unipolar sensor paired with a N-pole leading edge radial magnetized magnet, switching of the sensor occurs over a smaller activation range (e.g., a distance of less than 0.8 mm). Unlike omnipolar sensors, which operate on both the N-pole and the S-pole of the magnet, and over a wider activation range (e.g., between 6 mm and 11 mm), the S-pole reactive sensor of the present disclosure is responsive to only the N-pole of the magnet, thus increasing accuracy of the fluid-level sensor.

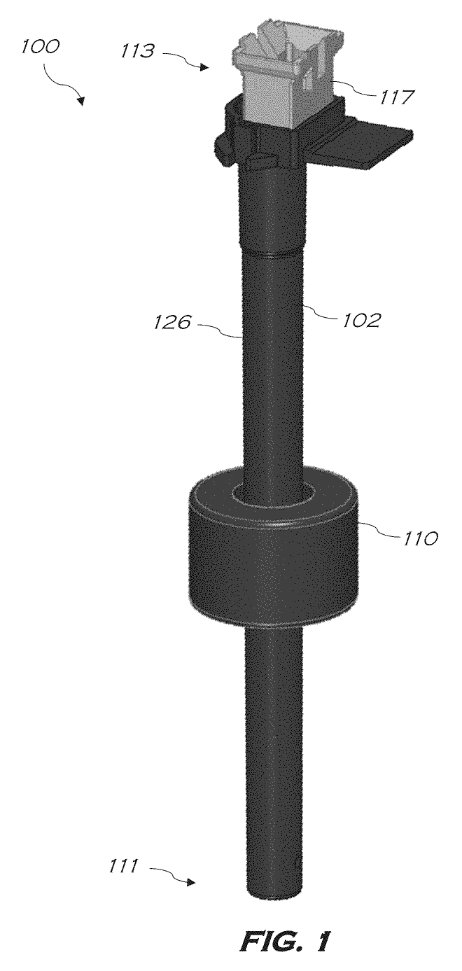

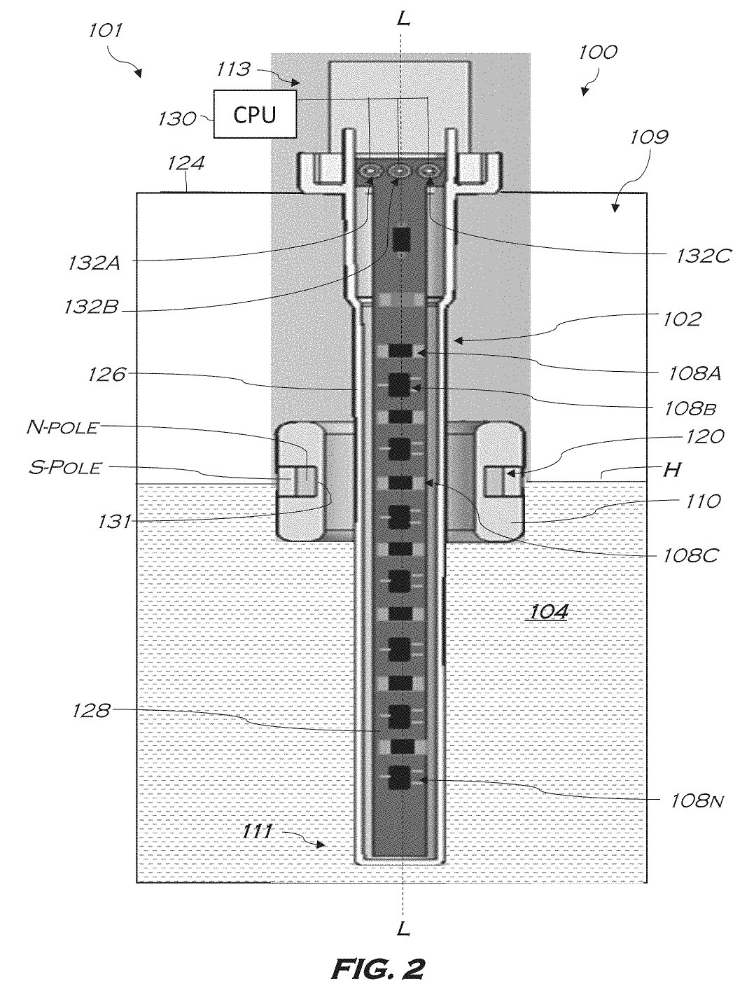

Referring now to FIGS. 1-2, a system including a fluid level sensor according to embodiments of the disclosure will be described. As shown, the fluid-level sensor (hereinafter “sensor”) 100 of the system 101 may include a tube 102 immersed in a fluid 104, the tube 102 containing a plurality of unipolar switches 108A-N extending at least partially along a lengthwise axis of the tube 102. For ease of explanation, an end of the tube 102 disposed within the fluid 104 of a containment vessel 109 (e.g., a fluid tank) will be hereinafter referred to as a distal end 111 of the sensor 100, while an end of the tube 102 located external to the containment vessel 109 will be hereinafter referred to as a proximal end 113 of the sensor 100. As shown, the proximal end 113 of the tube 102 may include a cap 117, which is removable to permit access to the interior of the tube 102.

A float 110 concentrically surrounds the tube 102, and is configured to float in the fluid 104, and to move axially relative to the tube 102 as an amount (e.g., volume) or a height ‘H’ of the fluid level changes within the containment vessel 109, such as a tank. As will be described in greater detail below, a permanent magnet 120 is coupled to the float 110. During operation, the plurality of unipolar switches 108A-N are responsive to a magnetic field produced by the permanent magnet 120 so as to switch, for example, from an open position to a closed position, and therefore provide an indication of the height of the fluid 104 within the containment vessel 109.

More specifically, the tube 102 may be a non-magnetic tube fixed with respect to a top wall 124 of the containment vessel 109, as shown, or to a bottom wall 125 of the containment vessel 109. The float 110 floats on the surface of the fluid 104, allowing the float 110 to move up and down along an outside surface 126 of the tube 102. In exemplary embodiments, the tube 102 and the float 110 are circular and concentrically positioned with respect to one another, and share a same central axis ‘L’ as the tube 102. A printed circuit board (PCB) 128 may be located within the tube 102, and the plurality of unipolar switches 108A-N may be physically and electrically coupled thereto. In some embodiments, the PCB 128 is a flexible PCB extending substantially an entire height/length of the tube 102. Although not shown, the PCB 128 may further include coupled thereto an encoder, a data bus, a power line, and a ground line. In some embodiments, the PCB 128 may include a series of small rigid printed circuit boards, which may be interconnected using a flexible printed circuit board or wiring.

As shown, the plurality of unipolar switches 108A-N each have a specific vertical position in the tube 102. The positions of each of the unipolar switches 108A-N may be set to any desired position and spacing within the tube 102, thus permitting the sensor 100 to have high resolution. The permanent magnet 120 is fixed within the float 110 so that the permanent magnet 120 fully or partially surrounds the tube 102. Furthermore, the permanent magnet 120 may be axially or radially magnetized, and can produce a magnetic field of sufficient magnitude and direction an adjacent unipolar switch in order to initiate the desired switching effect. In exemplary embodiments, the magnetization direction of either the axially or radially magnetized permanent magnet 120 is parallel, or substantially parallel, to the axis of the tube 102. In the non-limiting embodiment shown, the permanent magnet 120 includes a north-pole positioned concentrically within a south-pole, wherein the north-pole defines a leading edge 131 of the permanent magnet 120.

In exemplary embodiments, each output of the plurality of unipolar switches 108A-N is connected to an input of a processing unit 130 via a set of pins 132A-C. In some embodiments, the set of pins 132A-C is coupled to an encoder unit and a data bus (not shown). In other embodiments, the plurality of unipolar switches 108A-N and the set of pins 132A-C are electrically coupled to a sensor circuit (not shown). As is known in the art, the processing unit 130 refers, generally, to any apparatus for performing logic operations, computational tasks, control functions, etc. A processor may include one or more subsystems, components, and/or other processors. A processor may include various logic components operable using a clock signal to latch data, advance logic states, synchronize computations and logic operations, and/or provide other timing functions. During operation, the processing unit 130 may receive signals from the set of pins 132A-C or transmitted over a LAN and/or a WAN (e.g., T1, T3, 56 kb, X.25), broadband connections (ISDN, Frame Relay, ATM), wireless links (802.11, Bluetooth, etc.), and so on.

During use, when the sensor 100 is placed in the fluid 104, the float 110 floats at the surface of the fluid 104, and may move up and down along the length of the tube 102 as the height ‘H’ of the fluid 104 changes. The particular unipolar sensor closest to the magnetic field of the permanent magnet 120 (e.g., unipolar switch 108C) is then either closed or opened, resulting in a change in resistance, which is output via the set of pins 132A-C and received by the processing unit 130 or sensor circuit. Based on the resistance value observed when the unipolar switch 108C is closed, the processing unit or sensing circuit can recognize the height ‘H’ of the fluid 104. Alternatively, in the case that each of the plurality of unipolar switches 108A-N is spaced at a known axial position within the tube 102, the position of the float 110 along the exterior surface 126 of the tube 102 may be readily determined, thereby yielding a digital level sensor for measuring the level of the fluid 104 in which the tube 102 is immersed.

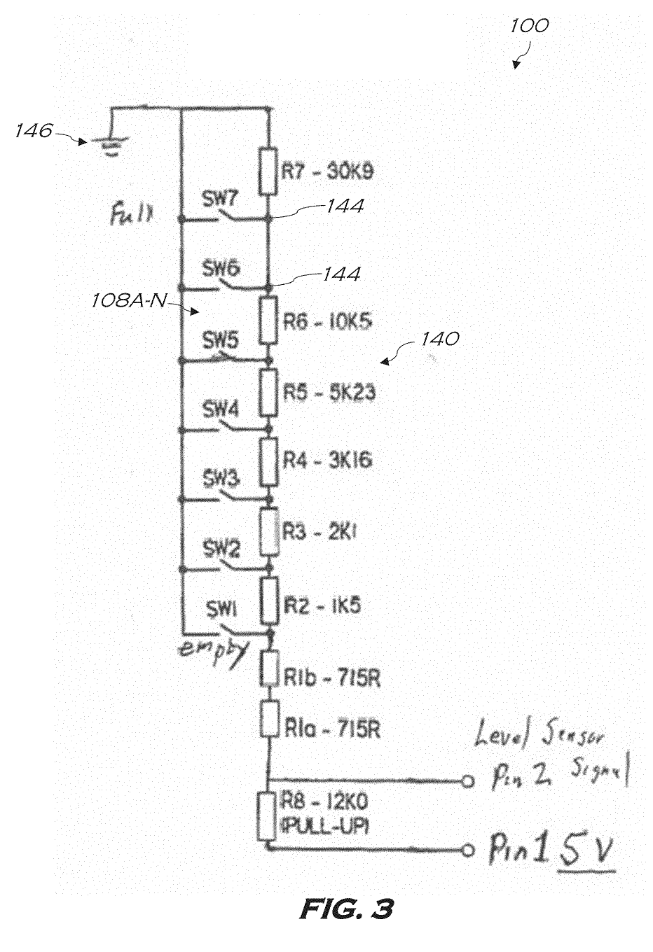

FIG. 3 is a schematic diagram showing the interconnection of the plurality of switches 108A-N of the sensor 100. Discrete voltage levels corresponding to each switch point are developed using a resistor ladder construction, which can be extended to any number of levels allowing for deep tank applications. Variable switch spacing schemes can also be devised to suit tanks with spherical or other varying cross sections. As configured, the sensor 100 may produce a signal dependent on the highest positioned unipolar switch having one of its switch contact elements activated. This may be done with the use of a resistor ladder 140 comprising a set of series connected resistors R1-R7 defining interconnecting nodes 144 and having known voltage connected across the resistor ladder 140. In one embodiment, the resistor ladder 140 has an upper end attached to a voltage (e.g. 12 V, 24 V, etc.) 146 and a lower end attached to ground.

Each node 144 may be connected to one of the magnetically activated unipolar switches SW1-SW7 such that when a particular magnetically activated unipolar switch is activated by the permanent magnet 120, the switch connects the corresponding node 144 to ground. In this way, as the float 110 rises or lowers to activate an adjacent switch of SW1-SW7, the voltage is increased or decreased as a function of float height. In the non-limiting embodiment shown, an activated (i.e., closed) SW7 may indicate a full fluid level, while an activated SW1 may indicate a low fluid level. Furthermore, in various embodiments, each of the resistors R1-R7 may be of uniform or different values. One will appreciate that the number of switches and resistors may vary depending on the application. For example, when the fluid level in a vessel is deep, and high resolution is desired, particularly towards the bottom of the vessel, then the number and/or position of the switches may be increased.

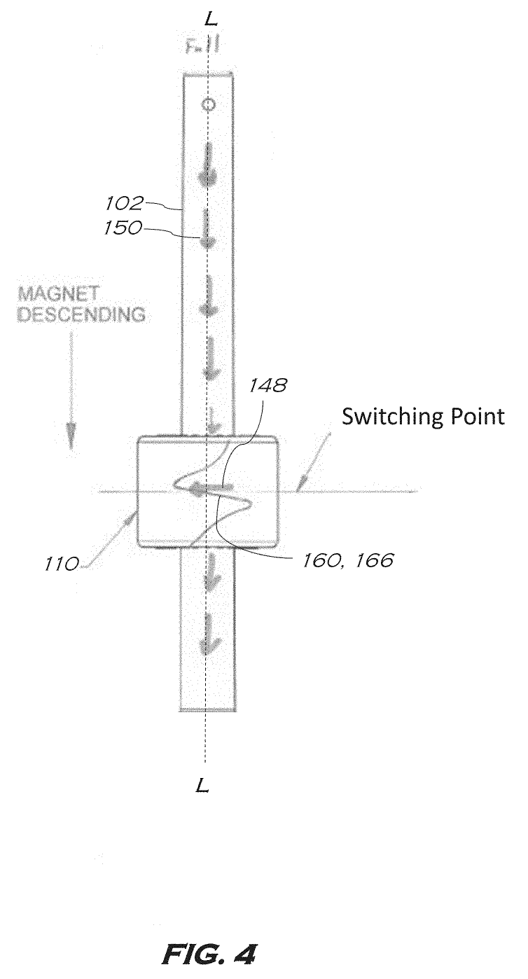

Referring now to FIGS. 3 and 4, operation of the unipolar switches 108A-N of the sensor 100 will be described in greater detail. In the embodiment shown, the direction of the permanent magnet's magnetization 148 is perpendicular, or substantially perpendicular, to the sensitive direction 150 of the unipolar switches 108A-N, which is parallel or substantially parallel to the axis ‘L’ of the tube 102. In exemplary embodiments, each of the plurality of unipolar switches 108A-N is responsive to only one pole of the permanent magnet 120 contained within the float 110. For example, in the case that each of the plurality of unipolar switches 108A-N is a S-pole switch, a leading edge of the permanent magnet 120, i.e., a portion of the permanent magnet 120 that is closest to the switch or that first encounters the switch as the float 110 descends with the fluid 104, generates a response in the switch contact elements to change the unipolar switch from an open position to a closed position.

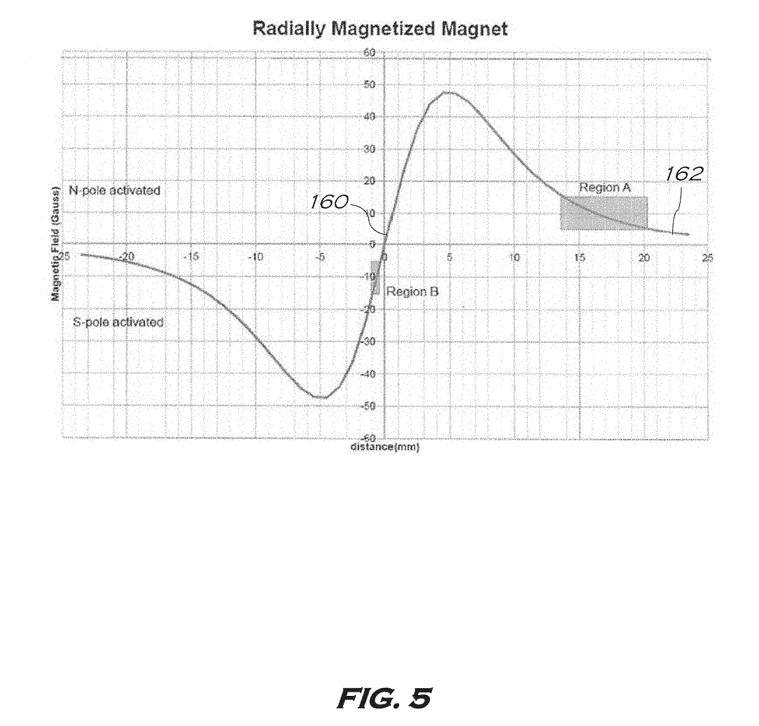

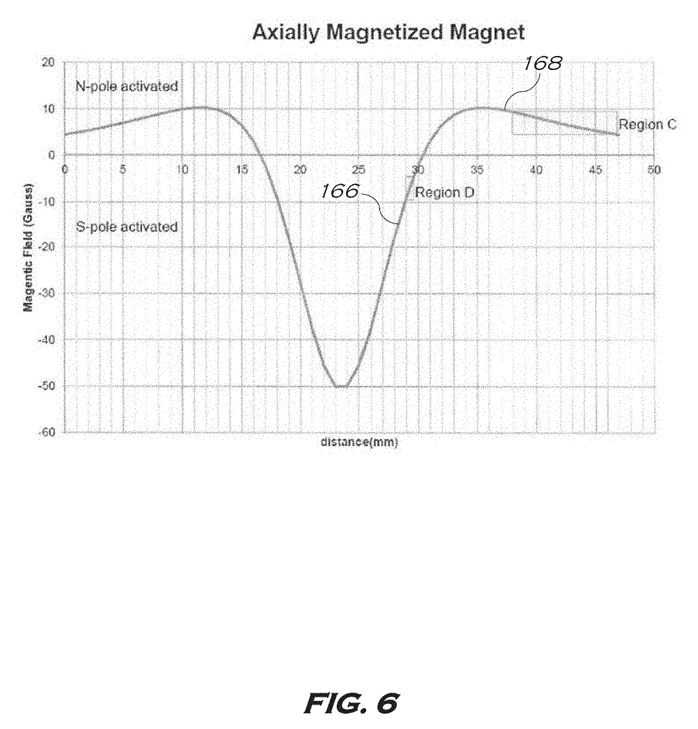

The output signal of a plurality of unipolar switches 108A-N as the float descends with the fluid 104 is illustrated in FIGS. 5-6. As shown in FIG. 5, improved switch point accuracy may be attained using a S-pole selective sensor and pairing it with a radially magnetized magnet using the N-pole magnet as the approaching/leading edge. The S-pole activated unipolar sensor paired with the radially magnetized magnet results in better accuracy, as shown by the activation range, “Region B,” of an equivalent −15 Gauss (G) to −5 G sensor. For example, as shown, the activation range is negative and approximately 0.7 mm wide. In an exemplary embodiment, the S-pole activated unipolar sensor switches on an inner slope 160 in Region B, instead of along an outer slope 162 in Region A, which may correspond to a switch response of an omnipolar switch. As demonstrated, the sensor activation range of Region B is smaller than the sensor activation range of Region A, thus resulting in reduced positional error of the sensor 100.

As shown in FIG. 6, improved switch point accuracy can also be attained by using an S-pole activated unipolar switch and an axially magnetized magnet using the N-pole of the magnet as the approaching/leading edge. The S-pole activated unipolar sensor paired with the axially magnetized magnet results in better accuracy, as shown by the activation range, “Region D,” of a 9 G to 4 G sensor. For example, as shown, the activation range of Region D is negative and approximately 0.8 mm wide. In an exemplary embodiment, the S-pole activated unipolar sensor switches on an inner slope 166 in Region D, instead of along an outer slope 168 in Region C, which may correspond to a switch response of an omnipolar switch. As demonstrated, the sensor activation range of Region D is considerably smaller than the sensor activation range of Region C, thus resulting in reduced positional error of the sensor 100.

While the present disclosure has been described with reference to certain approaches, numerous modifications, alterations and changes to the described approaches are possible without departing from the sphere and scope of the present disclosure, as defined in the appended claims. Accordingly, it is intended that the present disclosure not be limited to the described approaches, but that it has the full scope defined by the language of the following claims, and equivalents thereof. While the disclosure has been described with reference to certain approaches, numerous modifications, alterations and changes to the described approaches are possible without departing from the spirit and scope of the disclosure, as defined in the appended claims. Accordingly, it is intended that the present disclosure not be limited to the described approaches, but that it has the full scope defined by the language of the following claims, and equivalents thereof.

What is claimed is:

1. A fluid-level sensor comprising:
a tube immersed in a fluid, the tube containing a plurality of unipolar switches;
a float concentrically surrounding the tube, the float configured to float in the fluid and to move relative to the tube in an axial direction as an amount of the fluid changes; and
a permanent magnet coupled to the float, wherein the plurality of unipolar switches are responsive to a magnetic field produced by the permanent magnet, and wherein the permanent magnet is one of: radially magnetized, and axially magnetized.

2. The fluid-level sensor of claim 1, further comprising a printed circuit board (PCB) contained within the tube, wherein the plurality of unipolar switches are coupled to the PCB.

3. The fluid-level sensor of claim 1, wherein the plurality of unipolar switches are one of: a south-pole activated switch, and a north-pole activated switch.

4. The fluid-level sensor of claim 1, further comprising one or more resistors electrically connected between the plurality of unipolar switches.

5. The fluid-level sensor of claim 1, wherein the permanent magnet is contained within the float.

6. The fluid-level sensor of claim 1, wherein each of the plurality of unipolar switches is responsive to only one pole of the permanent magnet.

7. The fluid-level sensor of claim 1, wherein each of the plurality of unipolar switches changes from an open position to a closed position in response to a negative magnetic field.

8. The fluid-level sensor of claim 7, wherein each of the plurality of unipolar switches has an activation range of less than 1.0 millimeter.

9. The fluid-level sensor of claim 8, wherein each of the plurality of unipolar switches has an activation range of less than 0.7 millimeter.

10. A system for detecting fluid-levels, the system comprising:
a tube immersed in a fluid, the tube containing a plurality of unipolar switches;
a float concentrically surrounding the tube, the float configured to float in the fluid and to move relative to the tube in an axial direction as a height of the fluid changes; and
a permanent magnet positioned within the float, wherein the plurality of unipolar switches are responsive to a magnetic field produced by the permanent magnet, and wherein the permanent magnet is one of: radially magnetized, and axially magnetized.

11. The system of claim 10, further comprising a printed circuit board (PCB) contained within the tube, wherein the plurality of unipolar switches are coupled to the PCB.

12. The system of claim 10, wherein the unipolar sensor is one of: a south-pole activated switch, and a north-pole activated switch.

13. The system of claim 10, further comprising one or more resistors electrically connected between the plurality of unipolar switches.

14. The system of claim 10, wherein each of the plurality of unipolar switches is responsive to only one pole of the permanent magnet.

15. The system of claim 10, further comprising a processing unit electrically coupled to one or more outputs of the plurality of unipolar switches.

16. The system of claim 10, wherein at least one switch of the plurality of unipolar switches changes from an open position to a closed position in response to a negative magnetic field, and wherein the at least one switch of the plurality of unipolar switches has an activation range of less than 1.0 millimeter.

17. The system of claim 16, wherein the at least one switch of the plurality of unipolar switches has an activation range of less than 0.7 millimeter.

18. A unipolar resistive ladder sensor comprising:
a tube immersed in a fluid, the tube containing a plurality of unipolar switches;
a float concentrically surrounding the tube, the float configured to float in the fluid and to move relative to the tube in an axial direction as a height of the fluid changes; and
a permanent magnet disposed within the float, wherein each of the plurality of unipolar switches is responsive to only one pole at a leading edge of the permanent magnet, and wherein the permanent magnet is one of: radially magnetized, and axially magnetized.

19. The unipolar resistive ladder sensor of claim 18, wherein at least one switch of the plurality of unipolar switches changes position in response to a negative magnetic field, and wherein the at least one switch of the plurality of unipolar switches changes position as the permanent magnet moves downward an axial distance of less than 1.0 millimeter.

20. The unipolar resistive ladder sensor of claim 18, wherein each of the plurality of unipolar switches is one of: a south-pole activated switch, and a north-pole activated switch.
